(19) United States
(12) Patent Application Publication
(10) Pub. No.: US 2017/0190440 A1
(43) Pub. Date: Jul. 6, 2017

(54) Actively Stabilized Drogue

(71) Applicant: Steven McLaughlin, Point Pleasant, NJ (US)

(72) Inventor: Steven McLaughlin, Point Pleasant, NJ (US)

(73) Assignee: United States of America as represented by the Secretary of the Navy, Patuxent River, MD (US)

(21) Appl. No.: 14/986,934

(22) Filed: Jan. 4, 2016

(51) Int. Cl. B64D 39/04; B64D 39/06; B64C 9/36

(52) U.S. Cl. CPC B64D 39/04; B64C 9/36; B64D 39/06

(57) ABSTRACT

An actively stabilized refueling drogue including a drogue canopy, drogue straits extending from the drogue canopy, a coupling body, a coupling shroud, a system of fins, and actuators. The coupling body is for connecting a flexible refueling hose to a receiver aircraft fuel intake, so that in-air refueling may occur The drogue struts terminate at the coupling body. The coupling shroud covers the coupling body. The system of fins is for stabilization of the drogue and is attached to the coupling shroud. The actuators are for actuating the fins to achieve aerodynamic stabilization. The actuators are manufactured from a solid state shape memory alloy, such that the fins may be actuated by applying thermal energy to the actuators.

### STATEMENT OF GOVERNMENT INTEREST

The invention described herein may be manufactured and used by or for the Government of the United States of America for governmental purposes without payment of any royalties thereon or therefor.

### BACKGROUND

An aerial refueling drogue may be defined, but without limitation, as a funnel shaped piece of equipment at the end of a hose, typically trailed behind a tanker aircraft, used in a certain method of aerial refueling (also referred to as hose and drogue aerial refueling). The hose extends from the tanker aircraft with a drogue disposed on the end of the hose, allowing a receiving aircraft to be refueled. In calm air, the aerial refueling drogue trails steadily behind the tanker aircraft, and presents an easy target for the receiving aircraft to engage. However, as turbulence or tanker motion is increased, drogue motion also increases, making it difficult for the receiver aircraft to engage the refueling drogue. Additionally, with the increased use of unmanned and autonomous/automated aerial refueling, the safety requirements associated with refueling will require small amplitudes of drogue motion. Therefore, there is a need for actively stabilized drogues.

Previous actively stabilized drogues utilize complicated large damage-prone mechanical systems. They typically rely on conventional methods for control surface actuation. These methods result a high potential for Foreign Object Debris/Damage (FOD) to the receiver aircraft, and present packaging issues when trying to stow the drogue system a refueling pod or stowage tunnel.

### SUMMARY

The present invention is directed to an actively stabilized drogue with the needs enumerated above and below.

The present invention is directed to an actively stabilized refueling drogue including a drogue canopy, drogue struts extending from the drogue canopy, a coupling body, a coupling shroud, a system of fins, and actuators. The coupling body is for connecting a flexible refueling hose to a receiver aircraft fuel intake, so that in-air refueling may occur. The drogue struts terminate at the coupling body. The coupling shroud covers the coupling body. The system of fins is for stabilization of the drogue and is attached to the coupling shroud. The actuators are for actuating the fins to achieve aerodynamic stabilization. The actuators are manufactured from a solid state shape memory alloy, such that the fins may be actuated by applying thermal energy to the actuators.

It is a feature of the present invention to provide an actively stabilized refueling drogue that minimizes the motion of a refueling drogue in flight about its natural trail position.

It is a feature of the present invention to provide an actively stabilized refueling drogue that is not bulky and has increased safety and efficiency.

It is a feature of the present invention to provide an actively stabilized refueling drogue that utilizes shape memory alloys to help stabilize the drogue.

### DRAWINGS

These and other features, aspects and advantages of the present invention will become better understood with reference to the following description and appended claims, and accompanying drawings wherein:

FIG. 1 is a perspective view of an embodiment of the actively stabilized drogue in operation;

FIG. 1A is a side perspective view of an embodiment of the actively stabilized drogue shown FIG. 1;

FIG. 2 is another side perspective view of an embodiment of the actively stabilized drogue;

FIG. 3 is side view of an embodiment of the coupling body;

FIG. 4 is a side view of an embodiment of the coupling shroud;

FIG. 5 is a side view of an embodiment of the coupling body and the coupling shroud;

FIG. 6 is a side view of an embodiment of the tin system and the actuator of FIG. 6;

FIG. 6A is a cross sectional view of the fin system and the actuator;

FIG. 6B is a side view of another embodiment of the fin system and the actuator; and,

FIG. 8 is a side view of another embodiment of the fin system and the actuator.

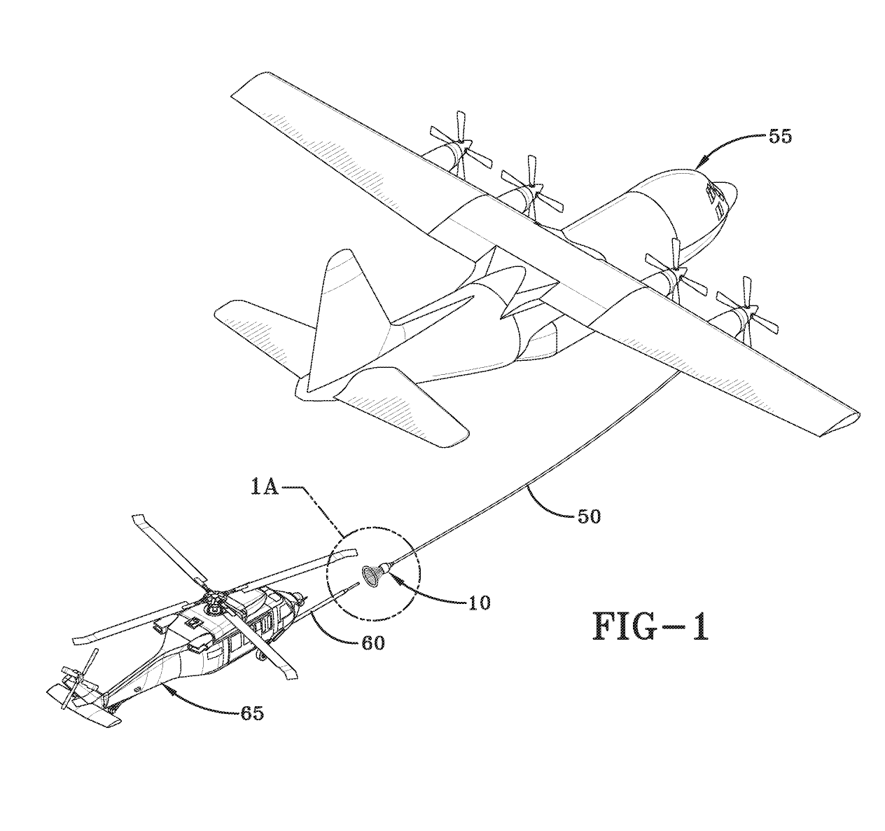

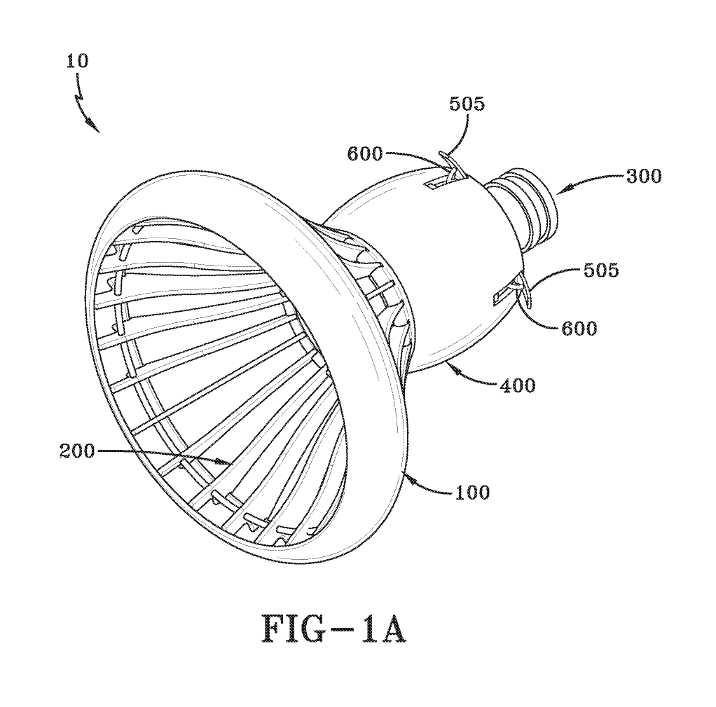

The preferred embodiments of the present invention are illustrated by way of example below and in FIGS. 1-8. As shown in FIGS. 1, 1A, and 2, the actively stabilized refueling drogue 10 includes a drogue canopy 100, drogue struts 200 extending from the drogue canopy 100, a coupling body 300, a coupling shroud 400, a system of fins 500, and actuators 600. The coupling body 300 is for connecting the flexible refueling hose 50 (attached to a refueling aircraft 55) to a receiver aircraft fuel intake 60 (attached to the aircraft being refueled 65), so that in-air refueling may occur. The drogue struts 200 terminate at the coupling body 300. The coupling shroud 400 covers the coupling body 300. The system of fins 500 are for stabilization of the drogue 10 and are attached to the coupling shroud 400. The actuators 600 are for actuating fins 505 in the system of fins 500 to achieve aerodynamic stabilization. The actuators 600 are manufactured from solid state shape memory alloy, such that the fins 505 may be actuated by applying thermal energy to the actuators 600.

In the description of the present invention, the invention will be discussed in a military aircraft environment however, this invention can be utilized for any type of application use of a drogue or the use of a towed device that must be stabilized.

A shape memory alloy (SMA) may be defined, but without limitation, as an alloy that has the ability to “remember” its shape. A shape memory alloy is capable of remembering two distinct shapes, one at a lower temperature, and one at a higher temperature. Such alloys can be constructed to achieve desired shape effects, and through tuning of material properties these shapes can occur at desired temperatures.

As shown in FIG. 3, the coupling shroud 400 can be removed, exposing the coupling body 300. The coupling shroud 400 is a covering over the coupling body 300. The coupling body 300 may include coupling latches 305 that enable a receiver aircraft fuel intake 60 (particularly its aerial refueling nozzle) to become and remain connected to the drogue 10. The coupling body 300 may also include at least one air turbine generator 310. The air turbine generator 310 provides electrical power for a control system, and provides electrical current to generate thermal energy to be applied to the actuators 600.

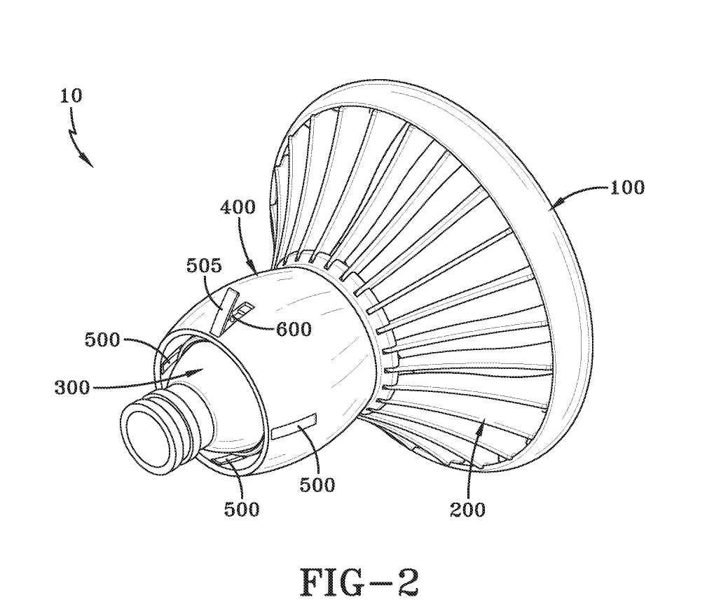

As shown FIG. 4, the coupling shroud 400 includes air inlets 405 and exits 410. The air inlets 405 and exits 410 provide a pathway for airflow to drive the air turbine generators 310.

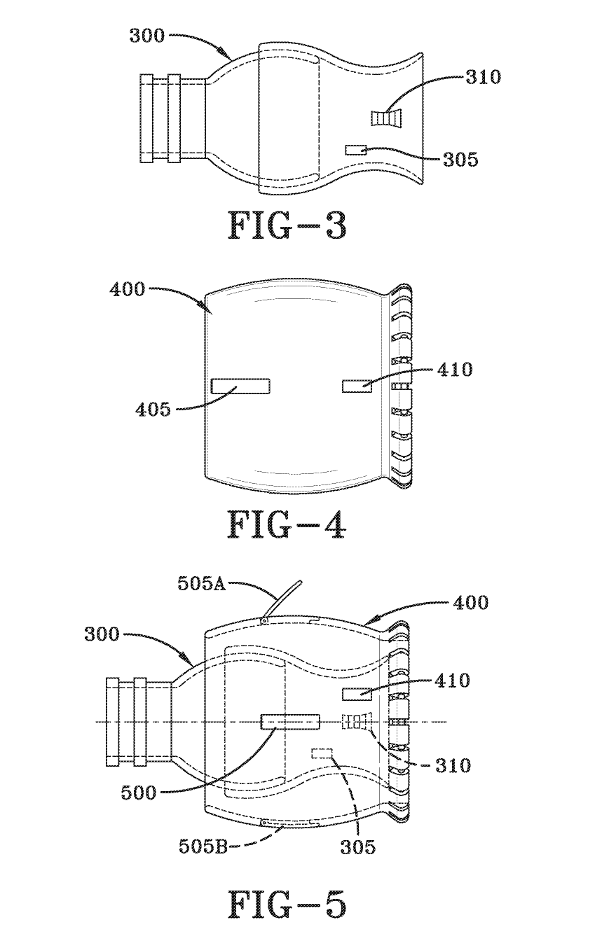

In one of the embodiments of the invention, as shown in FIGS. 1A and 2, the system of fins 500 has several fins 505 that are attached to or integrated with the coupling shroud 400. The fins 505 may be arranged orthogonally, in a system of four fins, including additional smaller orthogonal fin arrangements, or any other type of configuration that is practicable. As shown in FIG. 5, in the unactuated position the fins 505B are in a stowed position and flush with the outer mold line of the coupling shroud 400, while in the actuated position the fins 505A extend from the coupling shroud 400.

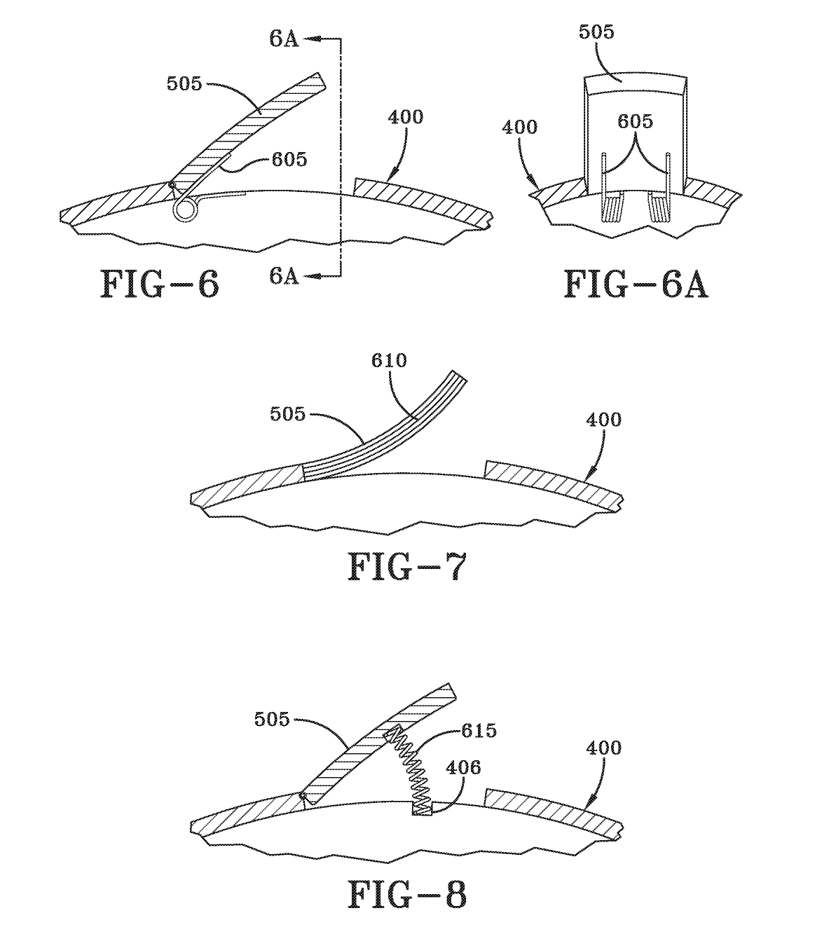

In one of the preferred embodiments, as shown FIG. 6, the actuators 600 may be a system of torsion springs 605. The fins 505 may be hinged conformal fins that are actuated by the system of torsion springs 605 made from a shape memory alloy. When a force from the fin 505 is required, the torsion springs 605 are actuated thermally, causing the fins 505 to extend to the actuated or open position. The torsion springs 605 can be actuated by passing a current through the torsion springs 605. As described earlier, the current may be supplied by the air turbine generator 310. When the force is no longer required, the heat is removed (the current stopped) causing the torsion springs 605 to return to their original shape, thereby, causing the fins 505 to return to the closed or stowed position. The current can be controlled by an on board control system, based on various inputs from a system of on-board computers or any other type of control system.

In another embodiment of e invention, as seen in FIG. 7, the actuators 600 may be integrated within the fins 505, while the fins 505 are integrated within the coupling shroud 400. In one of the embodiments, a system of wires 610 made of shape memory alloy may be integrated into a fin 505. The integrated shape memory alloy or actuators 600 may be actuated by passing a current through the thin wires. When the force is no longer needed, the current is stopped (heat is removed) causing the fins 505 to return to the closed or stowed position.

As shown in FIG. 8, in another embodiment, the actuators 600 may be compression springs 615 manufactured from shape memory alloy. The fins 505 may be conformal fins hinged at one end. At the other end of the fin 505, a compression spring 615 may extend from a notch 406 in the coupling shroud 400 to the fin 505. When the compression spring 615 is actuated, the fin 505 opens. In another embodiment of the invention, the compression springs 615 may be replaced with a magnetic shape memory alloy actuator.

The actively stabilized drogue 10 may also include a central processing unit (CPU) that can actuate the fins 505 when necessary. The actively stabilized drogue 10 may also include a CPU, a sensing system, and a power storage and generation unit. The central processing unit can contain a set of control laws, power management logic, and basic operational logic. The control laws will determine when actuation of the fins 505 is necessary based on input from the sensing system. The power generated by the air turbine generator(s) 310 will either be used immediately, or stored in a system of batteries and or super-capacitors for later use. Start up and shut down of the active control features will be controlled via the operational logic based on drogue extension and retraction position relative to the tanker.

When introducing elements of the present invention or the preferred embodiment(s) thereof, the articles “a,” “a,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

1. An actively stabilized refueling drogue, comprising:
a drogue canopy;
drogue struts extending from the drogue canopy;
a coupling body for connecting a flexible refueling hose to a receiver aircraft fuel intake,
so that in-air refueling may occur, the drogue struts terminating at the coupling body;
a coupling shroud, the coupling shroud covering the coupling body; and,
a system of fins for stabilization of the drogue, the fins being attached to the coupling shroud; and,
actuators for actuating the fins to achieve aerodynamic stabilization, the actuators manufactured from a solid state shape memory alloy, such that the fins may be actuated by applying thermal energy to the actuators.

2. The actively stabilized refueling drogue of claim 1, wherein the actuators are torsion springs.

3. The actively stabilized refueling drogue of claim 1, wherein the actuators are compression springs.

4. The actively stabilized refueling drogue of claim 1, wherein the actuators are integrated within the fins, the actuators being shape memory alloy wires disposed within the fins.
